(19) United States
(12) Patent Application Publication
(10) Pub. No.: US 2026/0003655 A1
(43) Pub. Date: Jan. 1, 2026

(54) GPU DIE ID VIRTUALIZATION IN CHIPLET

(71) Applicants: Advanced Micro Devices, Inc., Santa Clara, CA (US); ATI Technologies ULC, Markham (CA)

(72) Inventors: HaiKun Dong, Tianjin (CN); Alexander Fuad Ashkar, Winter Park, FL (US); Anthony Asaro, Toronto (CA); Fang Xia, Shanghai (CN); XiaoJing Ma, Shanghai (CN); Yong Zhang, Markham (CA); ZengRong Huang, Shanghai (CN); Qian Zong, Shanghai (CN); ShenYuan Chen, Shanghai (CN); WenBin Zhang, Hangzhou City (CN)

(21) Appl. No.: 18/754,371

(22) Filed: Jun. 26, 2024

(51) Int. Cl. G06F 9/455; G06F 9/48

(52) U.S. Cl. CPC G06F 9/45558; G06F 9/45545; G06F 9/4881; G06F 2009/45583

(57) ABSTRACT

An apparatus and method for efficiently accessing hardware resources in a virtualized environment. In various implementations, a computing system includes a first processing circuit and a second processing circuit that is a parallel data processing circuit. The second processing circuit includes multiple subdivisions, each with compute circuits, a memory subsystem, and a command processing circuit. The hypervisor running on the first processing circuit divides the second processing circuit into multiple partitions, each with a guest operating system and one or more subdivisions. A single mapping of multiple mappings includes a virtual function identifier that specifies a guest operating system, a virtual hardware resource identifier, and a corresponding physical hardware resource identifier. The hypervisor sends the mappings to at least the second processing circuit that uses the mappings to perform translations during execution of tasks. The first processing circuit does not perform translations.

### BACKGROUND

### Description of the Relevant Art

As computer performance increases for both desktops and servers, it becomes more desirable to efficiently utilize the available high performance. Standalone computing devices, such as desktop computers and server computers, consume space, limit access due to physical proximity or available networks, require maintenance, and limit its entirety of hardware resources to currently assigned tasks even if those tasks are not using all the available hardware resources. Virtualization is a technique that allows a single computing device to process tasks as if there are multiple computing devices. In such cases, users can execute multiple independent guest operating systems on the same hardware resources of the computing device.

Virtualization uses software that defines abstract layers that provide multiple virtual machines, each with its own guest operating system and a portion of the available hardware resources of the computing device. Each virtual machine can be assigned a portion of the available hardware resources corresponding to the tasks performed by the virtual machine, and the remaining hardware resources are then available for other tasks run on other virtual machines. Despite the benefits of virtualization, the realized improvements can be limited by competitive access by the virtual machines for the host processing circuit and the host operating system. The software, such as a hypervisor used to provide the abstract layers, requires data storage space in addition to data storage space for each of the multiple virtual machines. In addition, access latencies of memory and access latencies of computing hardware resources increase due to the abstract layers and corresponding virtual-to-physical translations that must be performed. To access particular hardware resources for a virtual machine when processing a task, the guest operating system uses the physical identifier specifying the hardware resource. For example, the computing device can include a parallel data processing circuit that utilizes a parallel data microarchitecture such as a graphics processing unit (GPU). The parallel data processing circuit includes multiple subdivisions. The hypervisor divides the parallel data processing circuit into multiple partitions, each with a guest operating system and two or more subdivisions. To identify a particular subdivision for assigning commands, the guest operating system performs translations between virtual hardware resource identifiers and physical hardware resource identifiers. These virtual-to-physical translations require access latency and data storage.

In view of the above, efficient methods and apparatuses for efficiently accessing hardware resources in a virtualized environment are desired.

### BRIEF DESCRIPTION OF THE DRAWINGS

FIG. 1 is a generalized diagram of a computing system that efficiently accesses hardware resources in a virtualized environment.

FIG. 2 is a generalized diagram of partitioning that provides efficient access of hardware resources in a virtualized environment.

FIG. 3 is a generalized diagram of an apparatus that efficiently accesses hardware resources in a virtualized environment.

FIG. 4 is a generalized diagram of a computing system that efficiently accesses hardware resources in a virtualized environment.

FIG. 5 is a generalized diagram of a method for efficiently accessing hardware resources in a virtualized environment.

FIG. 6 is a generalized diagram of a method for efficiently accessing hardware resources in a virtualized environment.

FIG. 7 is a generalized diagram of a method for efficiently accessing hardware resources in a virtualized environment.

FIG. 8 is a generalized diagram of a method for efficiently accessing hardware resources in a virtualized environment.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for efficiently accessing hardware resources in a virtualized environment are contemplated. In various implementations, a computing system includes a first processing circuit that is a general-purpose processing circuit and a second processing circuit that is a parallel data processing circuit. The second processing circuit utilizes a parallel data microarchitecture. Examples of the second processing circuit are a graphics processing unit (GPU), a digital signal processing circuit (DSP), a field programmable gate arrays (FPGA), an application specific integrated circuit (ASIC), or otherwise. The second processing circuit supports virtual-to-physical identifier translations between virtual hardware resource identifiers and physical hardware resource identifiers. The first processing circuit is no longer required to support these virtual-to-physical identifier translations, which reduces the overhead of guest operating systems and reduces latencies for the first processing circuit to issue tasks to the second processing circuit.

Typically, the first processing circuit maintains the virtual-to-physical identifier translations for hardware resource identifiers. For each submission of tasks and for each command within a task, the guest operating system running on the first processing circuit would perform these translations by accessing the stack memory of the guest operating system. These virtual-to-physical translations require access latency and data storage for each of the hardware resources of the second processing circuit, which burdens the first processing circuit. The latencies to issue tasks to the second processing circuit increase, the latencies for guest operating systems to complete operations before allowing a switch to another guest operating system increases, and the data storage required for each of the guest operating systems increase. Having the second processing circuit provide the virtual-to-physical identifier translations for hardware resource identifiers removes these burdens on the first processing circuit and increases performance.

The parallel data processing circuit includes multiple subdivisions. Each subdivision includes hardware resources such as one or more compute circuits, one or more levels of a memory subsystem, and a command processing circuit or controller. The first processing circuit assigns a unique physical hardware resource identifier to each of the subdivisions. To access the hardware resources of a subdivision of the second processing circuit, a command of a task uses the unique physical hardware resource identifier to specify the subdivision. The hypervisor running on the first processing circuit divides the parallel data processing circuit into multiple partitions, each with a guest operating system and one or more subdivisions. The guest operating system owns and has access to the corresponding one or more subdivisions. This partitioning of the second processing circuit by the hypervisor to support a virtualized environment is referred to as “spatial partitioning.”

In an implementation, a partition includes a single guest operating system supported by the hypervisor and this single guest operating system owns and has access to all of the subdivisions. In another implementation, a partition includes one or more guest operating systems, each owning and having access to two corresponding subdivisions. In yet another implementation, a partition includes one or more guest operating systems, each owning and having access to multiple corresponding subdivisions such as more than two subdivisions. The hypervisor running on the first processing circuit assigns a corresponding and unique virtual function identifier to each of the guest operating systems. The hypervisor also assigns a corresponding virtual hardware resource identifier to each of the subdivisions. However, the virtual hardware resource identifiers are not unique.

The values used for the virtual hardware resource identifiers can be reused within different partitions. In an implementation, a first partition has a virtual function identifier of 0 uniquely specifying its guest operating system and a subdivision with a virtual hardware resource identifier of 1. A second partition can have a virtual function identifier of 1 uniquely specifying its guest operating system and a subdivision with a virtual hardware resource identifier of 1. A single mapping can include a virtual function identifier, a virtual hardware resource identifier, and a corresponding physical hardware resource identifier. A mapping entry of multiple mappings can exist for each of the physical hardware resource identifiers.

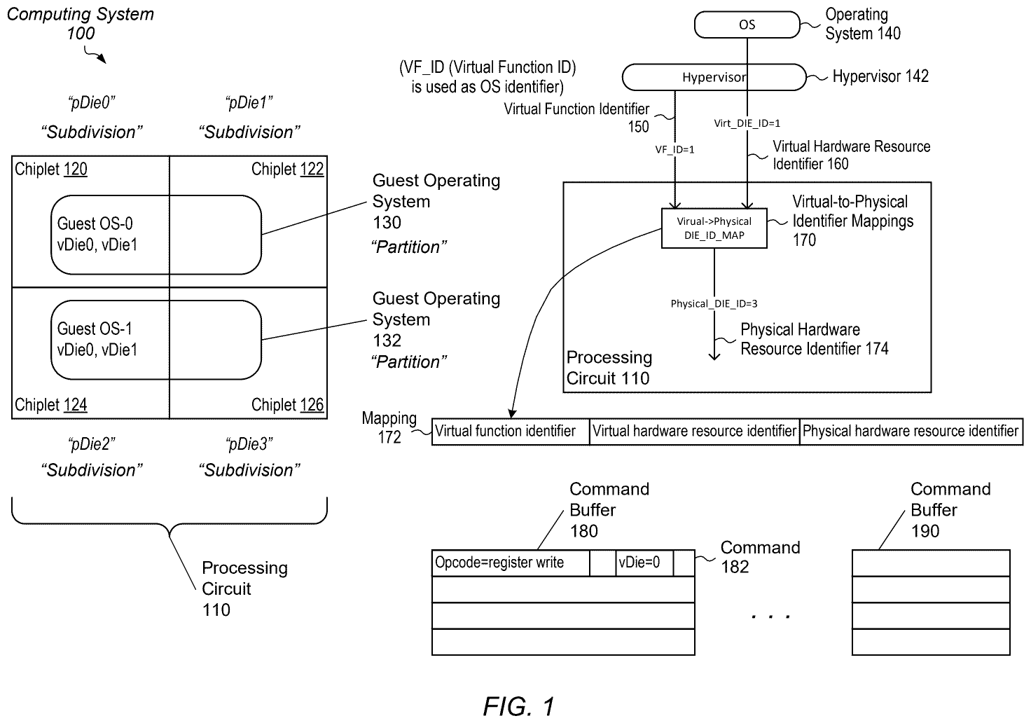

The hypervisor sends the mappings to the second processing circuit. In addition, the hypervisor sends these mappings to one or more of an interface circuit between the first processing circuit and the second processing circuit, and a memory controller. When the first processing circuit submits tasks to a command buffer in system memory, one of the interface circuit and the memory controller selects a memory region for data storage of the tasks based on the mappings. The first processing circuit does not perform translations. In an implementation, the memory region is a ring buffer in system memory and each combination of a virtual function identifier and a virtual hardware resource identifier has its own memory region separate from other memory regions for storing commands of tasks. When the corresponding subdivision of the second processing circuit accesses the commands of the task stored in the memory region, the command processing circuit (or controller) of the subdivision accesses a copy of the mappings at the second processing circuit to translate a virtual hardware resource identifier to a physical hardware resource identifier. To achieve access to the hardware resources of a subdivision, the command processing circuit uses the physical hardware resource identifier. From the perspective of the guest operating system, the physical hardware resource identifier is unknown. The circuitry of the second processing circuit accesses the mappings to perform the translation between the virtual hardware resource identifier and the physical hardware resource identifier. Further details of these techniques to efficiently access hardware resources in a virtualized environment are provided in the following description of FIGS. 1-8.

Turning now to FIG. 1, a generalized diagram is shown of a computing system 100 that efficiently accesses hardware resources in a virtualized environment. In an implementation, computing system 100 includes at least processing circuit 110. In various implementations, processing circuit 110 is a parallel data processing circuit that utilizes a parallel data microarchitecture. Examples of processing circuit 110 are a graphics processing unit (GPU), a digital signal processing circuit (DSP), a field programmable gate array (FPGA), an application specific integrated circuit (ASIC), and so forth. Processing circuit 110 retrieves commands of tasks from the command buffers 180-190. Processing circuit 110 reads the commands from the command buffers 180-190 and assigns the commands to one of multiple hardware subdivisions (or subdivisions). In an implementation, the subdivisions include chiplets 120-126.

As used herein, a “chiplet” is a semiconductor die (or die) fabricated separately from other dies, and then interconnected with these other dies in a single integrated circuit in a multi-chip module (MCM). On a single silicon wafer, only multiple chiplets are fabricated as multiple instantiated copies of particular integrated circuitry, rather than fabricated with other functional blocks that do not use an instantiated copy of the particular integrated circuitry. For example, the chiplets are not fabricated on a silicon wafer with various other functional blocks and processors on a larger semiconductor die such as an SoC. A first silicon wafer (or first wafer) is fabricated with multiple instantiated copies of integrated circuitry a first chiplet, and this first wafer is diced using laser cutting techniques to separate the multiple copies of the first chiplet. A second silicon wafer (or second wafer) is fabricated with multiple instantiated copies of integrated circuitry of a second chiplet, and this second wafer is diced using laser cutting techniques to separate the multiple copies of the second chiplet.

In some implementations, each of the chiplets 120-126 includes multiple circuit blocks, a memory subsystem, and a command processing circuit or controller. In an implementation, the multiple circuit blocks include graphics processing compute circuits such as geometry circuits, shader circuits and rasterizer circuits. In other implementations, other types of circuit blocks are used. In some implementations, each of the chiplets 120-126 also includes a communication bus or fabric, interface circuits supporting communication protocols used by other external circuits and so forth. The chiplets 120-126 are used to build processing circuit 110. Processing circuit 110 can also include other components not shown such as one or more levels of a cache memory subsystem, a dedicated local memory, fixed-function circuit blocks such as video encoders and decoders or other, and so on. In yet other implementations, the hardware subdivisions of processing circuit 110 are not chiplets, but other hardware resources created by subdividing processing circuit 110 based on design requirements.

The external processing circuit, such as a general-purpose processing circuit, assigns a unique physical hardware resource identifier to each of the subdivisions (e.g., chiplets 120-126). Although “chiplet” is used for the remainder of the description for computing system 100, it is understood that other types of hardware subdivision of processing circuit 110 are possible and contemplated. To access the hardware resources of one of the chiplets 120-126, typically, a command of a task uses the unique physical hardware resource identifier to specify the selected chiplet of chiplets 120-126. However, computing system 100 supports hardware virtualization and processing circuit 110 supports translations of virtual hardware resource identifiers to physical hardware resource identifiers. Therefore, operating system 140 running on the external processing circuit can use virtual hardware resource identifiers when submitting commands of tasks to run on processing circuit 110.

The hypervisor 142 running on the first processing circuit divides processing circuit 110 into multiple partitions, each with a guest operating system and one or more subdivisions. As shown, a first partition includes guest operating system 130 and chiplets 120-122 and a second partition includes guest operating system 132 and chiplets 124-126. The guest operating system 130 owns and has access to the corresponding chiplets 120-122. The guest operating system 132 owns and has access to the corresponding chiplets 124-126. As described earlier, this partitioning of processing circuit 110 by hypervisor 142 to support a virtualized environment is referred to as “spatial partitioning.”

Hypervisor 142 assigns a corresponding and unique virtual function identifier to each of the guest operating systems 130-132. Hypervisor 142 also assigns a corresponding virtual hardware resource identifier to each of the chiplets 120-126. However, the virtual hardware resource identifiers are not unique. The values used for the virtual hardware resource identifiers can be reused within a partition with within different partitions. In the illustrated implementation, the first partition has a virtual function identifier of 0 (Guest OS-0) uniquely specifying guest operating system 130 and virtual hardware resource identifiers of 0 and 1 (vDie0 and vDie1) specifying chiplets 120-122. The second partition has a virtual function identifier of 1 (Guest OS-1) uniquely specifying guest operating system 132 and virtual hardware resource identifiers of 0 and 1 (vDie0 and vDie1) specifying chiplets 124-126.

Hypervisor 142 sends mappings to processing circuit 110 to store in local memory as virtual-to-physical identifier mappings 170 (or mappings 170). A single mapping 172 can include a virtual function identifier, a virtual hardware resource identifier, and a corresponding physical hardware resource identifier. Although particular information is shown as being stored in the single mapping 172 of mappings 170, and in a particular contiguous order, in other implementations, a different order is used, and a different number and type of information is stored. A mapping entry of mappings 170 can exist for each of the physical hardware resource identifiers. Processing circuit 110 stores mappings 170 in a dedicated local memory, a cache of a cache memory subsystem, in configuration registers, or other. In some implementations, hypervisor 142 stores mappings 170 in memory mapped registers, and these memory mapped registers are storage locations in system memory within a particular memory region. Access to this memory region is guarded to provide security. In some implementations, in addition to processing circuit 110, one or more of an interface circuit (e.g., PCIe bus interface circuit) and a memory controller (e.g., system memory controller) has access to mappings 170 stored in the memory mapped registers.

During task submission, the external processing circuit (e.g., CPU, other) submits tasks to one of the command buffers 180-190 in system memory. One of the interface circuit and the memory controller selects a memory region for data storage of the tasks based on mappings 170. For example, the virtual function identifier 150 and the virtual hardware resource identifier 160 are used, and the mappings 170 provides the physical hardware resource identifier 174. Although processing circuit 110 is shown to include mappings 170, it is possible and contemplated that one or more of the interface circuit and the memory controller also includes mappings 170 or has access to a copy of mappings 170. However, the external processing circuit does not perform virtual-to-physical translations. Rather, one of the interface circuit and the memory controller performs the virtual-to-physical translation and selects a command buffer of command buffers 180-190 based on the virtual-to-physical translation results. In an implementation, the memory region is a ring buffer in system memory and each combination of a virtual function identifier and a virtual hardware resource identifier has its own memory region separate from other memory regions for storing commands of tasks. For example, chiplet 120 has a command buffer separate from a command buffer of each of chiplets 122-126. In an implementation, processing circuit 110 utilizes four command buffers, one for each of chiplets 122-126.

In an implementation, when chiplet 126 of processing circuit 110 accesses the commands of a task stored in command buffer 180, the command processing circuit (or controller) of chiplet 126 accesses mappings 170 to translate a virtual hardware resource identifier to a physical hardware resource identifier. For example, command 182 is a write command that includes the virtual hardware resource identifier shown as “vDie0.” To achieve access to the hardware resources of chiplet 124, which guest operating system 132 owns, the command processing circuit of chiplet 126 performs the virtual-to-physical translation and uses the corresponding physical hardware resource identifier, which is “pDie2” that specifies chiplet 124. From the perspective of the guest operating system 132, the physical hardware resource identifier is unknown. The circuitry (e.g., command processing circuit) of chiplet 126 accesses mappings 170 to perform the virtual-to-physical translation between the virtual hardware resource identifier and the physical hardware resource identifier.

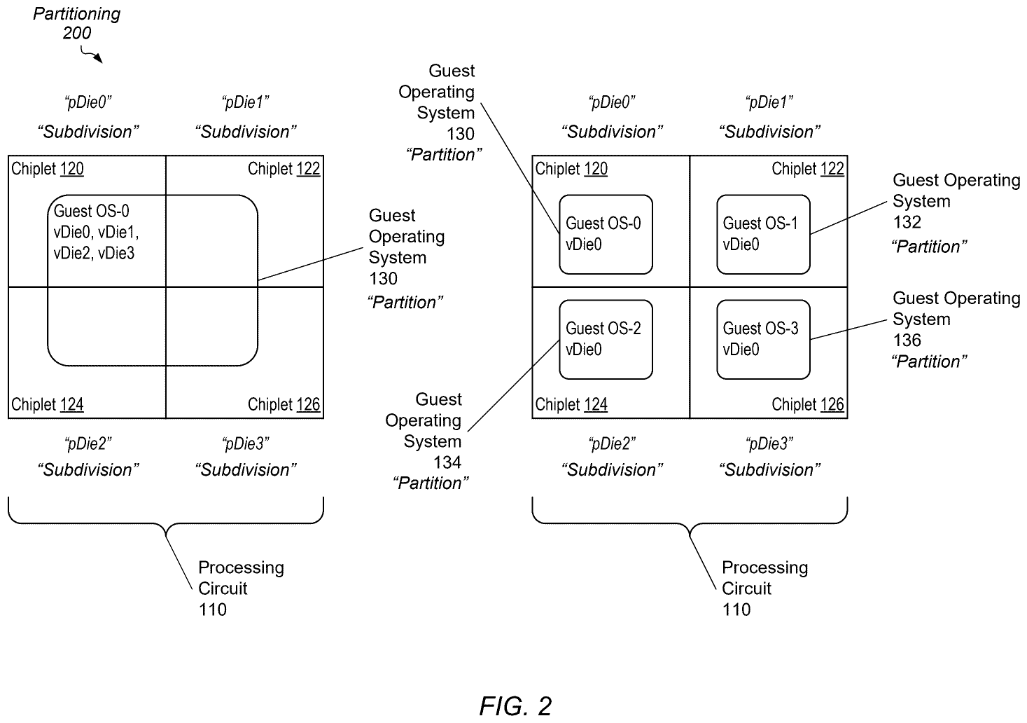

Turning now to FIG. 2, a generalized diagram is shown of partitioning 200 that efficiently access hardware resources in a virtualized environment. Circuitry and components previously described are numbered identically. In an implementation, processing circuit 110 is partitioned into a different number of partitions by a hypervisor based on design requirements. In the partitioning shown on the left side, the hypervisor (e.g., hypervisor 142) did not divide processing circuit 110 into multiple partitions, but rather, used a single partition. This single partition includes guest operating system 130 and chiplets 120-126. The values used for the virtual hardware resource identifiers do not match the values used for the physical hardware resource identifiers. Therefore, virtual-to-physical translations are still used and performed by processing circuit 110.

In the partitioning shown on the right side, the hypervisor (e.g., hypervisor 142) divides processing circuit 110 into four partitions. These four partitions include guest operating systems 130, 132, 134 and 136. The first partition in the top left corner of processing circuit 110 includes guest operating system 130 and chiplet 120. The second partition in the top right corner of processing circuit 110 includes guest operating system 132 and chiplet 122. The third partition in the bottom left corner of processing circuit 110 includes guest operating system 134 and chiplet 124. The fourth partition in the bottom right corner of processing circuit 110 includes guest operating system 136 and chiplet 126. The values used for the virtual hardware resource identifiers do not match the values used for the physical hardware resource identifiers. Therefore, virtual-to-physical translations are still used and performed by processing circuit 110.

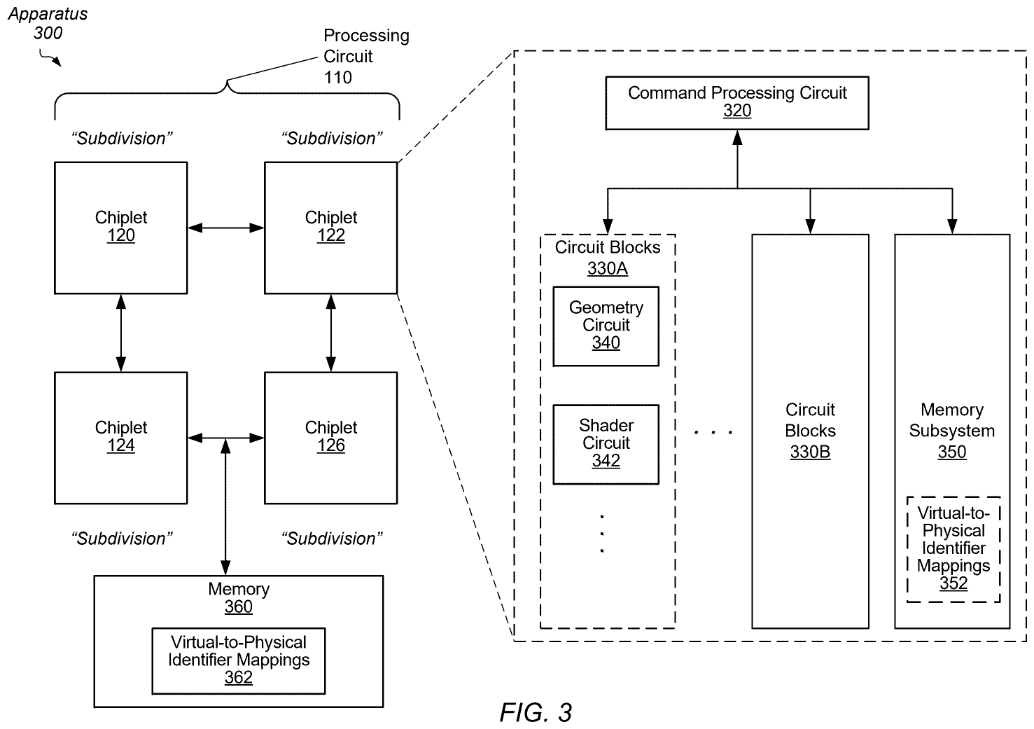

Turning now to FIG. 3, a generalized diagram is shown of apparatus 300 that efficiently accessing hardware resources in a virtualized environment. Circuitry and components previously described are numbered identically. It should be understood that the implementation of processing circuit 110 having four subdivisions, such as chiplets 120-126, is merely representative of one implementation. In other implementations, processing circuit 110 can have another number of chiplets (subdivisions) based on design requirements. In various implementations, processing circuit 110 also includes memory 360. Memory 360 can be a dedicated local memory or a local cache memory subsystem. Memory 360 stores virtual-to-physical identifier mappings 362 (or mappings 362). In various implementations, mappings 362 store the same type of information as mappings 170 (of FIG. 1). Processing circuit 110 retrieved mappings 362 from memory mapped registers, which are particular storage location in system memory with guarded access.

In various implementations, each of chiplets 120-126 includes an instantiation of circuitry used in each of chiplets 120-126. An implementation of the circuitry included in chiplet 122 is shown. Each of chiplets 120, 124 and 126 includes the same circuitry. As shown, chiplet 122 includes at least command processing circuit 320, circuit blocks 330A-330B and memory subsystem 350. In some implementations, command processing circuit 320 includes the functionality of a command processing circuit (or command processor) of a GPU. The command processing circuit 535 retrieves commands of a task, such as a kernel, from a command buffer and determines when to dispatch the commands to circuit blocks 330A-330B. In an implementation, chiplet 122 stores at least a portion of mappings 162 as virtual-to-physical identifier mappings 352 (or mappings 352) as a local copy for more efficient access during virtual-to-physical identifier translations.

The circuit blocks 330A-330B can provide a variety of functionalities based on design requirements. Circuit 330B includes an instantiation of the circuitry of circuit block 330A. In an implementation, circuit blocks 330A-330B perform graphics processing functionality. In an implementation, processing circuit 110 is used to perform graphics processing on pixels to be displayed on a display device. A three-dimensional (3D) model of an object that is visible in a frame on the display device is represented by a set of triangles, other polygons, or patches which are processed in the graphics pipelines provided by circuit blocks 330A-330B. The triangles, other polygons, or patches are collectively referred to as primitives. In some implementations, circuit block 330A includes geometry circuit 340, shader circuit 342 and other circuits.

In an implementation, geometry circuit 340 includes the functionality of a vertex shader and a hull shader that process high order primitives such as patches of the 3D model. Geometry circuit 340 sends the processed high order primitives to shader circuit 342 that generates lower order primitives from the higher order primitives. Other circuit blocks (not shown) process the lower order primitives by performing replication, shading, sub-dividing, culling, rasterizing, color blending and so forth. In this implementation, each of the circuit blocks 330A-330B, and accordingly, each of chiplets 120-126, provide the functionality of graphics processing of pixels. However, in other implementations, the provided functionality can be one of a variety of other functionalities. Regardless of the provided functionality, apparatus 300 supports virtual-to-physical identifier translations at processing circuit 110, which offloads the host operating system and corresponding processing circuit (e.g., a CPU) from maintaining resources to perform the virtual-to-physical identifier translations.

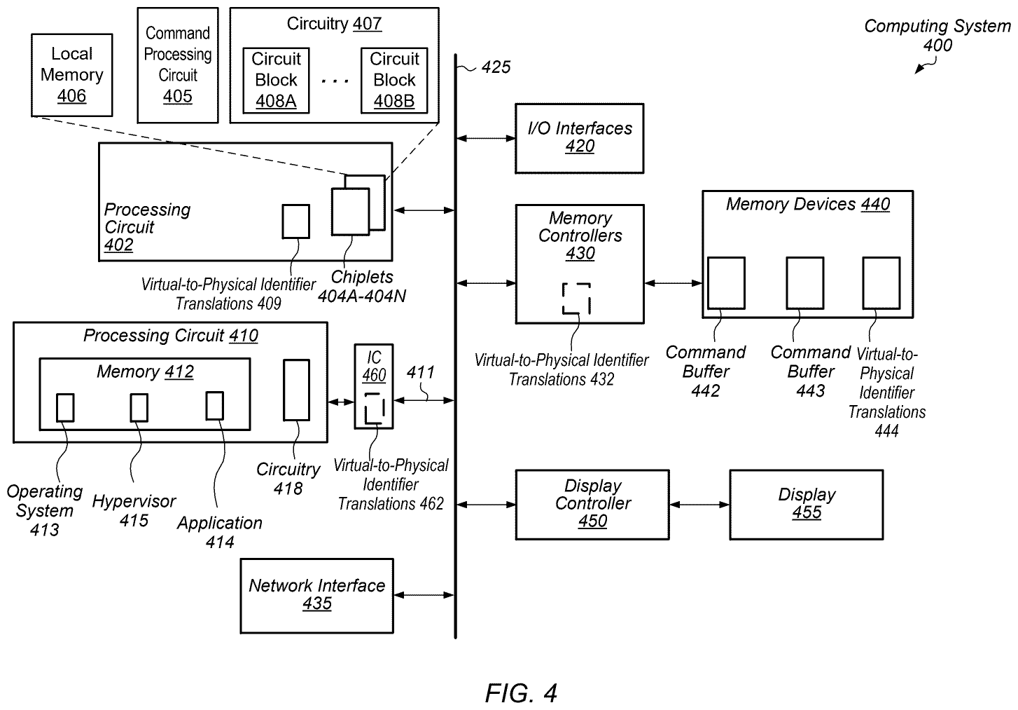

Turning now to FIG. 4, a generalized diagram is shown of a computing system 400 that efficiently accesses hardware resources in a virtualized environment. In an implementation, the computing system 400 includes at least processing circuits 402 and 410, input/output (I/O) interfaces 420, bus 425, network interface 435, memory controllers 430, memory devices 440, display controller 450, and display device 455. In other implementations, computing system 400 includes other components and/or computing system 400 is arranged differently. For example, power management circuitry, and phased locked loops (PLLs) or other clock generating circuitry are not shown for ease of illustration. In various implementations, the components of the computing system 400 are on the same die such as a system-on-a-chip (SOC). In other implementations, the components are individual dies in a system-in-package (SiP) or a multi-chip module (MCM). A variety of computing devices use the computing system 400 such as a desktop computer, a laptop computer, a server computer, a tablet computer, a smartphone, a gaming device, a smartwatch, and so on.

Processing circuits 402 and 410 are representative of any number of processing circuits which are included in computing system 400. In an implementation, processing circuit 410 is a general-purpose central processing unit (CPU) and circuitry 418 includes multiple general-purpose processor cores, each with one or more general-purpose pipelines that execute instructions of a particular instruction set architecture (ISA). Memory 412 represents a local hierarchical cache memory subsystem of processing circuit 410. Memory 412 stores source data, intermediate results data, results data, and copies of data and instructions stored in memory devices 440.

Processing circuit 410 is coupled to bus 425 via interface circuit (IC) 460 and interface 411. In an implementation, interface 411 uses the communication protocol of a peripheral component interconnect (PCI) bus, a PCI-Extended (PCI-X), or a PCIE (PCI Express) bus. In an implementation, processing circuit 410 has a direct point-to-point (P2P) connection with processing circuit 402 that bypasses bus 425. Processing circuit 410 receives, via interface 411, copies of various data and instructions, such as a host operating system such as operating system 413, a hypervisor 415, one or more device drivers, one or more applications such as application 414, and/or other data and instructions.

In one implementation, processing circuit 402 is a parallel data processing circuit with a highly parallel data microarchitecture, such as a GPU. The processing circuit 402 can be a discrete device, such as a dedicated GPU (dGPU), or the processing circuit 402 can be integrated (an iGPU) in the same package as another processing circuit. Other parallel data processing circuits that can be included in computing system 400 include digital signal processing circuits (DSPs), field programmable gate arrays (FPGAs), application specific integrated circuits (ASICs), and so forth. In various implementations, processing circuit 402 has the circuitry and functionality of processing circuit 110 (of FIGS. 1-3).

Processing circuit 402 includes multiple chiplets 404A-404N. In various implementations, chiplets 404A-404N have the same functionality as chiplets 120-126 (of FIGS. 1-3). As shown, each of chiplets 404A-404N includes command processing circuit 405, local memory 406 and circuit blocks 408A-408B of circuitry 407. In some implementations, the circuit blocks 408A-408B can include multiple, parallel computational lanes. Each lane is also referred to as a single instruction multiple data (SIMD) lane. Within a given row across the SIMD lanes, a vector arithmetic logic circuit includes the same circuitry and functionality, and operates on the same instruction, but different data associated with a different thread. A particular combination of the same instruction and a particular data item of multiple data items is referred to as a “work item.” A work item is also referred to as a thread. The multiple work items (or multiple threads) are grouped into thread groups, where a “thread group” is a partition of work executed in an atomic manner. In some implementations, a thread group includes instructions of a function call that operates on multiple data items concurrently. Each data item is processed independently of other data items, but the same sequence of operations of the subroutine is used. As used herein, a “thread group” is also referred to as a “work block” or a “wavefront.” Tasks performed by processing circuit 402 can be grouped into a “workgroup” that includes multiple thread groups (or multiple wavefronts). The hardware, such as circuitry, of the command processing circuit 405 schedules a workgroup to the circuit blocks 408A-408B.

In some implementations, application 414 is a highly parallel data application that provides multiple kernels to be executed on circuit blocks 408A-408B. The high parallelism offered by the hardware of circuit blocks 408A-408B is used for real-time data processing. Examples of real-time data processing are rendering multiple pixels, image blending, pixel shading, vertex shading, and geometry shading. In such cases, each of the data items of a wavefront is a pixel of an image. Circuit blocks 408A-408B can also be used to execute other threads that require operating simultaneously with a relatively high number of different data elements (or data items). Examples of these threads are threads for scientific, medical, finance and encryption/decryption computations.

In some implementations, computing system 400 utilizes a communication fabric (“fabric”), rather than the bus 425, for transferring requests, responses, and messages between the processing circuits 402 and 410, the I/O interfaces 420, the memory controllers 430, the network interface 435, and the display controller 450. When messages include requests for obtaining targeted data, the circuitry of interfaces within the components of computing system 400 translates target addresses of requested data. In some implementations, the bus 425, or a fabric, includes circuitry for supporting communication, data transmission, network protocols, address formats, interface signals and synchronous/asynchronous clock domain usage for routing data.

Memory controllers 430 are representative of any number and type of memory controllers accessible by processing circuits 402 and 410. While memory controllers 430 are shown as being separate from processing circuits 402 and 410, it should be understood that this merely represents one possible implementation. In other implementations, one of memory controllers 430 is embedded within one or more of processing circuits 402 and 410 or it is located on the same semiconductor die as one or more of processing circuits 402 and 410. Memory controllers 430 are coupled to any number and type of memory devices 440.

Memory devices 440 are representative of any number and type of memory devices. For example, the type of memory in memory devices 440 includes Dynamic Random Access Memory (DRAM), Static Random Access Memory (SRAM), NAND Flash memory, NOR flash memory, Ferroelectric Random Access Memory (FeRAM), or otherwise. Memory devices 440 store at least instructions of an operating system, one or more device drivers, and application. In some implementations, an application stored on memory devices 440 is a highly parallel data application such as a video graphics application, a shader application, or other. Copies of these instructions can be stored in a memory or cache device local to processing circuit 410 and/or processing circuit 402.

I/O interfaces 420 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB). Various types of peripheral devices (not shown) are coupled to I/O interfaces 420. Such peripheral devices include (but are not limited to) displays, keyboards, mice, printers, scanners, joysticks or other types of game controllers, media recording devices, external storage devices, and so forth. Network interface 435 receives and sends network messages across a network.

In various implementations, hypervisor 415 has the functionality of hypervisor 142 (of FIG. 1). For example, hypervisor 415 running on circuitry 418 of processing circuit 402 divides processing circuit 402 into multiple partitions, each with a guest operating system and one or more subdivisions. As described earlier, this partitioning of processing circuit 402 by hypervisor 415 to support a virtualized environment is referred to as “spatial partitioning.” Hypervisor 415 assigns a corresponding and unique virtual function identifier to each of the generated guest operating systems. Hypervisor 415 also assigns a corresponding virtual hardware resource identifier to each of the subdivisions such as chiplets 404A-404N. However, the virtual hardware resource identifiers are not unique. The values used for the virtual hardware resource identifiers can be reused within different partitions.

Hypervisor 415 sends virtual-to-physical identifier mappings 444 (or mappings 444) to memory mapped registers in memory devices 440. Access to this memory region is guarded to provide security. In some implementations, hypervisor 415 sends virtual-to-physical identifier mappings 409 (or mappings 409) to processing circuit 402 to store in local memory 406, or processing circuit 402 retrieves the mappings from memory devices 440. A single mapping of the mappings can include a virtual function identifier, a virtual hardware resource identifier, and a corresponding physical hardware resource identifier as shown earlier for mapping 172 (of FIG. 1). A mapping can exist for each of the physical hardware resource identifiers. In some implementations, in addition to processing circuit 402, one or more of interface circuit 460 (e.g., PCIe bus interface circuit) and memory controllers 430 (e.g., system memory controller) have access to mappings 462 and 432, respectively.

During task submission, processing circuit 410 submits tasks to one of the command buffers 442-443 in system memory provided by memory devices 440. One of interface circuit 460 and the memory controllers 430 selects a memory region for data storage of the tasks based on the mappings associated with the tasks. For example, the virtual function identifier and the virtual hardware resource identifier can be used. However, processing circuit 410 executing operating system 413 does not perform virtual-to-physical translations. Rather, one of the interface circuit 460 and the memory controllers 430 performs the virtual-to-physical translation and selects a command buffer of command buffers 442-443 based on the virtual-to-physical translation results. In an implementation, the memory region is a ring buffer in system memory and each combination of a virtual function identifier and a virtual hardware resource identifier has its own memory region separate from other memory regions for storing commands of tasks. In an implementation, when 404A of processing circuit 402 accesses the commands of a task stored in command buffer 443, the command processing circuit (or controller) 405 accesses mappings 409 to translate a virtual hardware resource identifier to a physical hardware resource identifier.

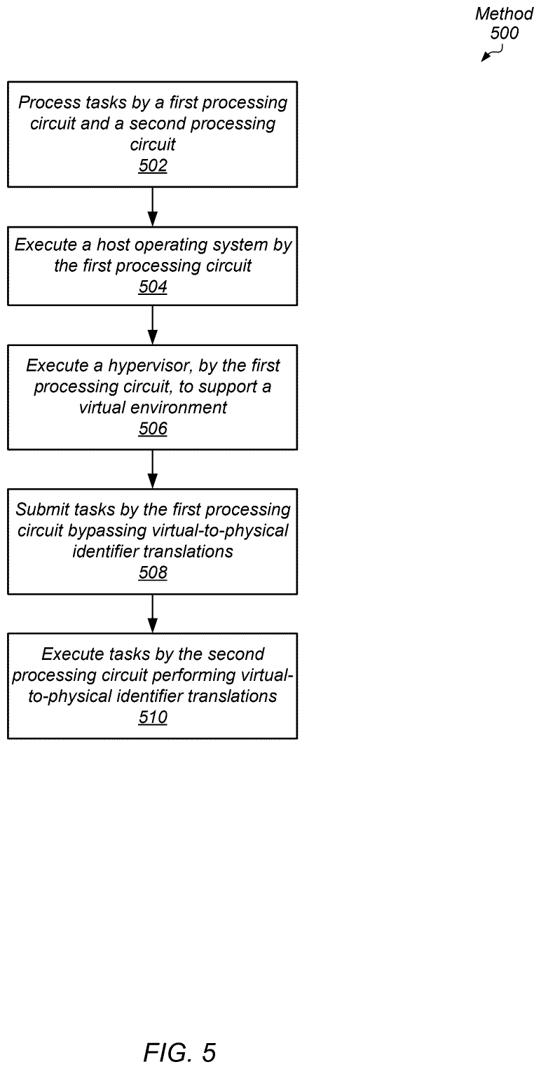

Referring to FIG. 5, a generalized diagram is shown of a method 500 for efficiently processing multiplication and accumulate operations for matrices in applications. For purposes of discussion, the steps in this implementation are shown in sequential order. However, in other implementations some steps occur in a different order than shown, some steps are performed concurrently, some steps are combined with other steps, and some steps are absent.

A first processing circuit and a second processing circuit process tasks (block 502). The first processing circuit executes a host operating system (block 504). The first processing circuit executes a hypervisor to support a virtual environment (block 506). While bypassing virtual-to-physical identifier translations the first processing circuit submits tasks (block 508). The second processing circuit executes tasks by performing virtual-to-physical identifier translations (block 510).

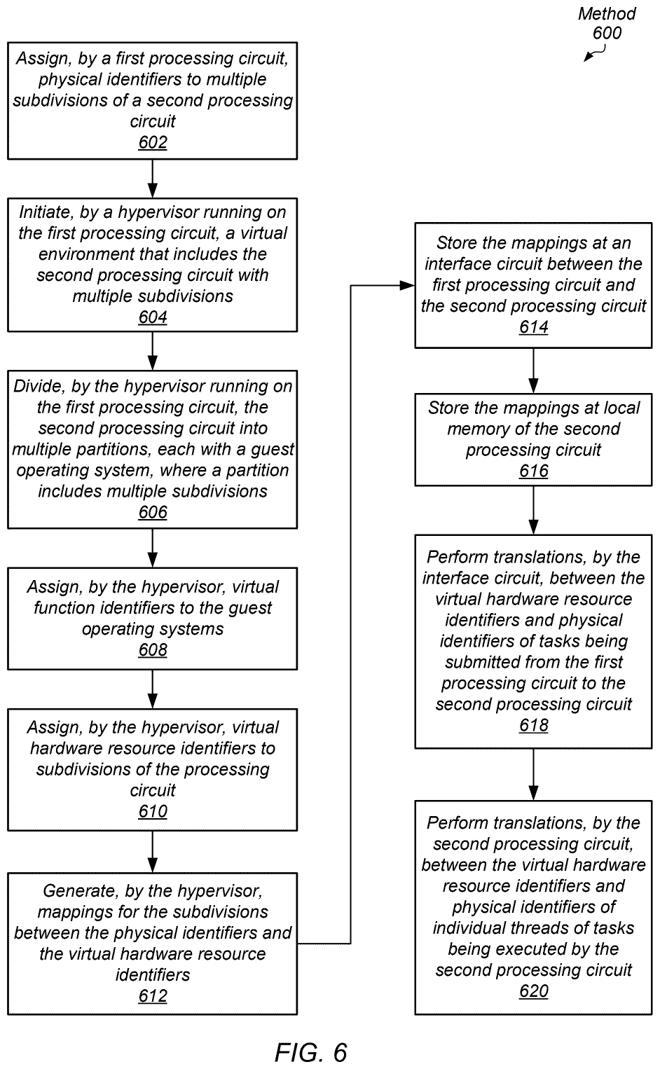

Referring to FIG. 6, a generalized diagram is shown of a method 600 for efficiently processing multiplication and accumulate operations for matrices in applications. A first processing circuit assigns physical identifiers to multiple subdivisions of a second processing circuit (block 602). A hypervisor running on the first processing circuit initiates a virtual environment that includes the second processing circuit with multiple subdivisions (block 604). The hypervisor running on the first processing circuit divides the second processing circuit into multiple partitions, each with a guest operating system, where a partition includes multiple subdivisions (block 606). The hypervisor assigns virtual function identifiers to the guest operating systems (block 608). The hypervisor assigns virtual hardware resource identifiers to subdivisions of the processing circuit (block 610). The hypervisor generates mappings for the subdivisions between the physical identifiers and the virtual hardware resource identifiers (block 612).

The hypervisor stores the mappings at an interface circuit between the first processing circuit and the second processing circuit (block 614). The hypervisor stores the mappings at local memory of the second processing circuit (block 616). The interface circuit performs translations between the virtual hardware resource identifiers and physical identifiers of tasks being submitted from the first processing circuit to the second processing circuit (block 618). The second processing circuit performs translations between the virtual hardware resource identifiers and physical identifiers of individual threads of tasks being executed by the second processing circuit (block 620).

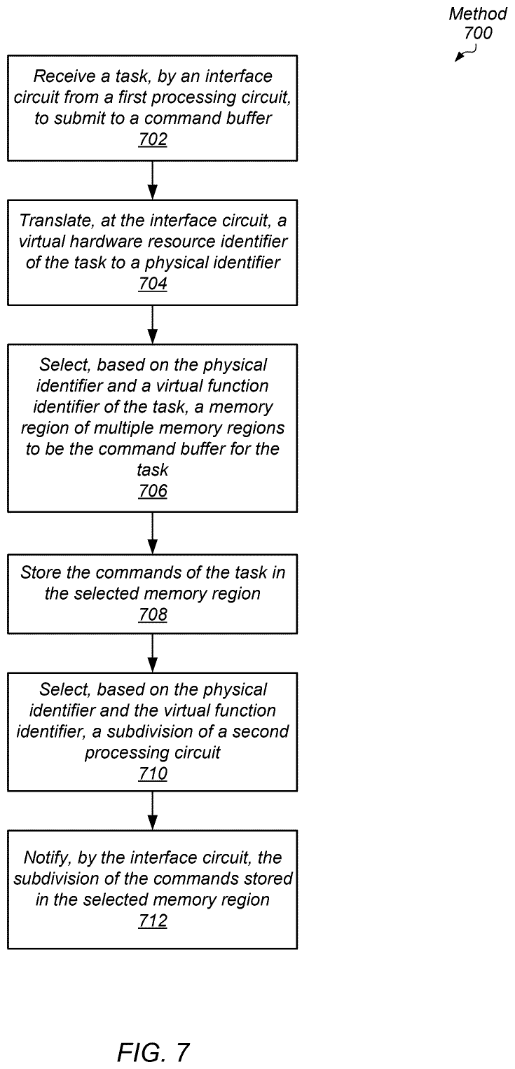

Turning now to FIG. 7, a generalized diagram is shown of a method 700 for efficiently processing multiplication and accumulate operations for matrices in applications. An interface circuit from a first processing circuit receives a task to submit to a command buffer (block 702). The interface circuit translates a virtual hardware resource identifier of the task to a physical identifier (block 704). The interface circuit selects, based on one or more of the physical identifier and a virtual function identifier of the task, a memory region of multiple memory regions to be the command buffer for the task (block 706). The interface circuit stores the commands of the task in the selected memory region (block 708). The interface circuit selects, based on the physical identifier and the virtual function identifier, a subdivision of a second processing circuit (block 710). The interface circuit notifies the subdivision of the commands stored in the selected memory region (block 712).

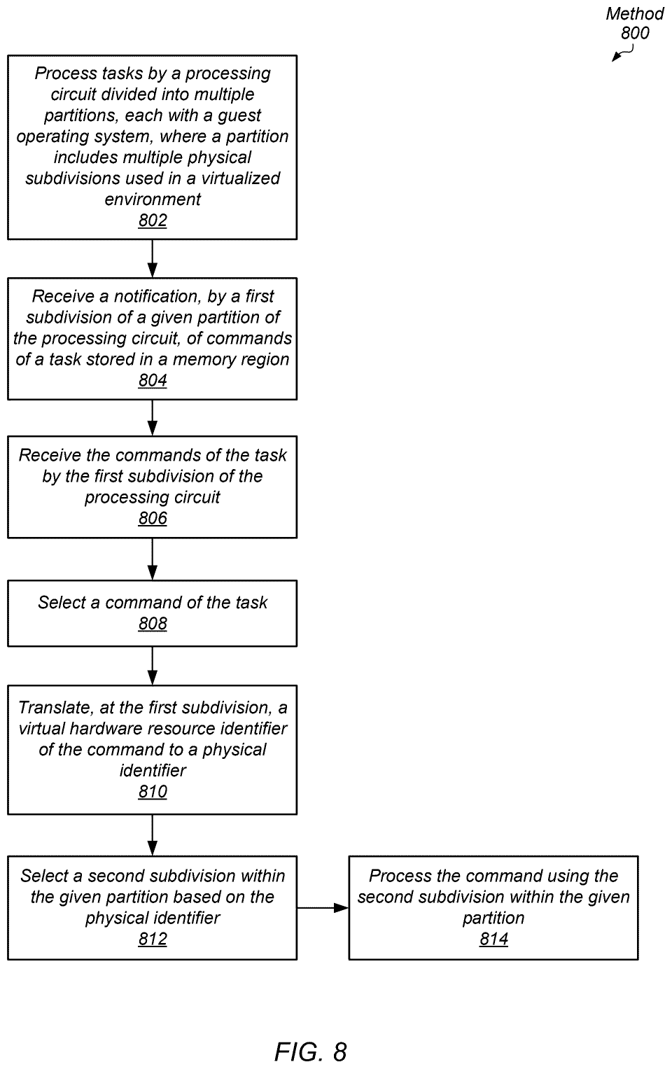

Turning now to FIG. 8, a generalized diagram is shown of a method 800 for efficiently processing multiplication and accumulate operations for matrices in applications. A processing circuit is divided into multiple partitions, each with a guest operating system, where a partition includes multiple physical subdivisions used in a virtualized environment. The processing circuit processes tasks (block 802). A first subdivision of a given partition of the processing circuit receives a notification of commands of a task stored in a memory region (block 804). The first subdivision of the processing circuit receives the commands of the task (block 806).

A command processing circuit of the first subdivision selects a command of the task (block 808). The command processing circuit of the first subdivision translates a virtual hardware resource identifier of the command to a physical identifier (block 810). The command processing circuit of the first subdivision selects a second subdivision within the given partition based on the physical identifier (block 812). The hardware resources of the second subdivision within the given partition processes the command (block 814).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
a command processing circuit; and
a plurality of subdivisions, each comprising circuitry configured to process commands of a task generated by a processing circuit; and
wherein the command processing circuit is configured to:
receive a command comprising a virtual hardware resource identifier;
translate the virtual hardware resource identifier to a physical identifier; and
send the command to a first subdivision of the plurality of subdivisions to be processed based at least in part on the physical identifier specifying the first subdivision.

2. The apparatus as recited in claim 1, wherein to translate the virtual hardware resource identifier, the command processing circuit is further configured to access virtual-to-physical identifier mappings stored in a local memory of the apparatus.

3. The apparatus as recited in claim 2, wherein each of the plurality of subdivisions is a chiplet of a plurality of chiplets of the processing circuit.

4. The apparatus as recited in claim 2, wherein the apparatus is divided into a plurality of partitions by a hypervisor executing on the processing circuit, wherein each of the plurality of partitions comprises a guest operating system and at least two subdivisions of the plurality of subdivisions.

5. The apparatus as recited in claim 4, wherein to translate the virtual hardware resource identifier, the command processing circuit is further configured to access the virtual-to-physical identifier mappings using a virtual function identifier specifying a guest operating system.

6. The apparatus as recited in claim 2, wherein the command processing circuit is used in a second subdivision different from the first subdivision.

7. The apparatus as recited in claim 6, wherein each of the first subdivision and the second subdivision is controlled by a given guest operating system.

8. A method, comprising:
generating tasks by a first processing circuit;
processing tasks by a second processing circuit comprising a plurality of subdivisions, each comprising circuitry configured to process commands of a task generated by the first processing circuit;
receiving, by the second processing circuit, a command of a task generated by the first processing circuit comprising a virtual hardware resource identifier;
translating, by the second processing circuit, the virtual hardware resource identifier to a physical identifier; and
sending, by the second processing circuit, the command to a first subdivision of the plurality of subdivisions to be processed based at least in part on the physical identifier specifying the first subdivision.

9. The method as recited in claim 8, wherein to translate the virtual hardware resource identifier, the method further comprises accessing virtual-to-physical identifier mappings stored in a local memory of the second processing circuit.

10. The method as recited in claim 9, wherein each of the plurality of subdivisions is a chiplet of a plurality of chiplets of the second processing circuit.

11. The method as recited in claim 9, further comprising dividing the second processing circuit is divided into a plurality of partitions by a hypervisor executing on the first processing circuit, wherein each of the plurality of partitions comprises a guest operating system and at least two subdivisions of the plurality of subdivisions.

12. The method as recited in claim 11, wherein to translate the virtual hardware resource identifier, the method further comprises accessing the virtual-to-physical identifier mappings using a virtual function identifier specifying a guest operating system.

13. The method as recited in claim 9, wherein a command processing circuit of the second processing circuit is used in a second subdivision different from the first subdivision.

14. The method as recited in claim 13, wherein each of the first subdivision and the second subdivision is controlled by a given guest operating system.

15. A computing system comprising:
a first processing circuit; and
a second processing circuit comprising:
a command processing circuit; and
a plurality of subdivisions, each comprising circuitry configured to process commands of a task generated by the first processing circuit; and
wherein the command processing circuit is configured to:
receive a command comprising a virtual hardware resource identifier;
translate the virtual hardware resource identifier to a physical identifier; and
send the command to a first subdivision of the plurality of subdivisions to be processed based at least in part on the physical identifier specifying the first subdivision.

16. The computing system as recited in claim 15, wherein to translate the virtual hardware resource identifier, the command processing circuit is further configured to access virtual-to-physical identifier mappings stored in a local memory of the second processing circuit.

17. The computing system as recited in claim 16, wherein each of the plurality of subdivisions is a chiplet of a plurality of chiplets of the second processing circuit.

18. The computing system as recited in claim 16, wherein the second processing circuit is divided into a plurality of partitions by a hypervisor executing on the first processing circuit, wherein each of the plurality of partitions comprises a guest operating system and at least two subdivisions of the plurality of subdivisions.

19. The computing system as recited in claim 18, wherein to translate the virtual hardware resource identifier, the command processing circuit is further configured to access the virtual-to-physical identifier mappings using a virtual function identifier specifying a guest operating system.

20. The computing system as recited in claim 16, wherein the command processing circuit is used in a second subdivision different from the first subdivision.
